(19) United States
(12) Patent Application Publication
(10) Pub. No.: US 2004/0099736 A1
(43) Pub. Date: May 27, 2004

(54) Inventory control and identification method

(76) Inventor: Yoram Neumark, Irvine, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/443,601

(22) Filed: May 21, 2003

Related U.S. Application Data
(63) Continuation-in-part of application No. 10/304,671, filed on Nov. 25, 2002.

(51) Int. Cl. G06F 17/60

(52) U.S. Cl. 235/385

(57) ABSTRACT

A system and method which allows the identity of assets and their physical locations to be mapped and associated with one another. The invention includes a locator tool which receives an input from an ultra-wide band communications network, which allows the tool to determine its own spatial location and thereby the spatial locations of various objects such as furniture, computer equipment, and structural components such as doors, windows to be identified and located and thereafter mapped in the form of architectural layout, diagrams, and the like. The invention is also an inventory system as well as a verification system that allows objects or assets to be inventoried, tracked, or verified against purchasing lists or the like.

### RELATED APPLICATIONS

This is a continuation-in-part application of a prior filed and currently pending application having Ser. No. 10/304,671 and file date of Nov. 25, 2002.

### BACKGROUND OF THE INVENTION

### INCORPORATION BY REFERENCE

Applicant(s) hereby incorporate herein by reference, any and all U.S. patents, U.S. patent applications, and other documents and printed matter cited or referred to in this application.

### FIELD OF THE INVENTION

The present invention relates to inventory systems and, more particularly, to a method and system for determining the inventory and location of assets.

### DESCRIPTION OF RELATED ART

In large organizations and others, an important requirement of asset management is the need to first have an accurate tabulation and second, to know the physical location of those assets in the inventory.

Traditionally, an item is added to an inventory when it is acquired and then updated periodically. The task of performing periodic updates to the inventory is tedious and fraught with errors. Some automated systems require that a barcode label attached to the item be scanned (to identify the asset) and the location manually entered. Other systems attach electronic tags that act as electronic locators of the associated asset-some acting as transponders to identify themselves when polled and others as locator beacons. The former requires extensive manual interaction that is prone to error and the latter expensive equipment that itself can be lost or damaged, or, is quite simply overkill.

Due to the periodic nature of most inventories, “instant” updates to an item's location are seldom required. Rather, an accurate last known location is of prime importance.

In other situations, such as for architectural purposes, the location of an item, such as water pipes, lighting fixtures, junction boxes, etc., is of prime importance to ensure among other things that the plans and drawings are accurate. Often changes are made during construction and afterwards that are never incorporated into the plans. In some instances, there is a need to locate the position where an item should be and has been placed.

In some industries, such as construction, there is a need to determine not only where items have been placed (installed) but also provide a measure of compliance. For example, after electrical equipment is installed at a construction site, the contractor produces a bill of materials for reimbursement. There is a need to not only produce but also verify that this bill of materials is correct and that the items have been installed in the proper locations.

The following art defines the present state of this field:

Neumark, U.S. Pat. No. 6,550,674 describes an inventory control and management method providing a combination mobile device for communication and for reading labels (R&C). The R&C reads an inventory label affixed to an item of inventory in the stores. A data file is created corresponding to the label reading and includes a time stamp taken at the time of the reading. The data file is imported into a computer data processor. A network of fixed distributed communication nodes (transceivers) is positioned over the inventory store for receiving temporal cyclic signature pulses from the R&C. At least three of the communication nodes are used to perform a triangulation for locating the R&C, and the location and the corresponding time is recorded. By comparing the time of a given reading of the label with a corresponding time of the triangulation, it is possible to determine where any item is located within the stores.

Barritz et al, U.S. 2002/0008621 describes a system and method which allows the identity of assets and their physical locations to be mapped and associated with one another. The invention includes a locator tool which receives an input which allows the tool to determine its own spatial location and thereby the spatial locations of various objects such as furniture, computer equipment, and structural components such as doors, windows to be identified and located and thereafter mapped in the form of architectural layout, diagrams, and the like. The invention is also an inventory system as well as a verification system that allows objects or assets to be inventoried, tracked, or verified against purchasing lists or the like.

Goodwin, III, U.S. Pat. No. 5,794,215 describes a method of optimizing electronic price label (EPL) systems which employs a three-dimensional graph of retry levels in a transaction establishment. The method includes the steps of determining locations of EPLs within the transaction establishment, determining locations of transmit and receive antennas that are used by a computer to communicate with the EPLs, determining retry levels for the EPLs, mapping the retry levels to locations within the transaction establishment, producing a three-dimensional graph of the retry levels within the area of the transaction establishment, and determining, from the graph, subareas within the area having retry levels above a predetermined maximum retry level. Once the subareas having higher retry levels are determined, the locations of the transmit and receive antennas may be changed and/or interfering structures may be moved until the retry levels of the subareas are below the predetermined maximum retry level.

DeTemple et al., U.S. Pat. No. 5,995,015 describes a system for communicating between a store computer and locations in the les of a retail facility. A hard-wired grid connects the store computer to a plurality of transceivers located in zones throughout the facility and the transceivers establish a wireless link to the locations. One embodiment is a product information display system in which the locations are fixed information display terminals, such as price displaying shelf tags. Another embodiment is an item tracking system, in which the locations are movable shopping carts or baskets.

Failing, Jr. et al., U.S. Pat. No. 6,016,481 describes an improved system for space management in retail stores. The space management system includes price display labels mounted on rails along the edges of shelves in a store. A communications link between the computer and the labels permits the computer to address each label by a logical address and to determine the physical location of each label to within a resolution of typically four feet. The system prepares price audit lists and adjacency audit lists that permit economical use of the time of store personnel during the audit. The lists are generated in such a way that the items on a particular list are physically contiguous; thus once the correct general area has been located by the auditor little additional time need be spent locating the individual items. In performing an audit of product facings, the user is able to use the display hardware, including the pushbutton on each label, as a data collection system for product facing information. In product location mode, the user starts at the first label at one end of a shelf and presses the button on the first label. The user moves to the second label, presses its button, moves to the third label, and the process is repeated for each label along the shelf, and for the rest of the shelves in the area being audited. This permits the system to collect information as to the sequence of labels along a rail.

Halperin et al., U.S. Pat. No. 6,105,004 describes a product monitoring system for monitoring a variety of products grouped according to their identities on shelves, including a central computer storing the identification of each group of products on the shelves; a plurality of electronic shelf labels, each located adjacent to a shelf for a group of products, communicating with the central computer, storing the identification of the respective group of products, displaying information relating to the respective group of products, and reading out the identification of the respective group of products; a plurality of portable units each to be carried by a user of the system; and a record memory for each portable unit. Each portable unit includes a read-in device capable of establishing a short-range communication link with the read-out device of each electronic shelf label for reading in the product identification and for recording same in the record memory for the respective portable unit.

Sutherland, U.S. Pat. No. 6,253,190 describes a shelf tag comprising a liquid crystal display having optical states which are stable without power and an interface that allows for each character element to be programmed easily by sweeping a programming device across the character element contacts with all power and signal requirements being supplied to the shelf tag by the programming device. The programming device can be integrated with a portable transaction computer equipped with a bar code reader or can be embodied in a stand-alone apparatus capable of receiving user input, displaying information and interfacing to the shelf tags. A method of using the shelf tags, the programming device and a radio frequency computer local area network are presented which automates many typical business applications such as inventory updating and simultaneously changing prices advertised on the shelf tags.

Brick et al., U.S. Pat. No. 6,269,342 describes an electronic pricing and display system using programmable electronic shelf tags. Programmable electronic shelf tags are used in connection with apparatus for programming the electronic shelf tags. Pricing and product information is stored in databases of a computer system for such purposes as inventory control and updating pricing information. A portable programming device is used to transmit programming data Methods are provided for fast and convenient modification of large numbers of electronic shelf tags located throughout a facility (e.g., a retail store).

Gelbman, U.S. 2001/0020935 A1 describes smart and dumb implementations of a stand-alone, remotely updateable, remotely alterable, flexible electronic label. The electronic label provides for displaying information in connection with a mammal, non-mammal, an item or location. The label includes a display assembly having electronic ink disposed on a support, one or more antennas for sending or receiving signals corresponding to one of instructions, programs, data or selected indicia to be displayed by said display assembly, a storage element in circuit with the antenna for storing the instructions, programs, data and indicia, and one or more processors for intelligently determining the indicia to be displayed by the display assembly, for controlling and coordinating operation of the label, and for generating output signals for instructing the display assembly to display the indicia.

Hook et al., U.S. 2001/0054005 A1 describes an electronic display tag system. The system has an electronic display tag including a display for displaying at least one of pricing data and product identification data, the display having bistable character elements or bistable pixels. The display tag has a decoder logic unit for decoding received programming data and for updating the display based on the programming data, the programming data being received wirelessly. The display tag also has a wireless transceiver, the wireless transceiver for converting a power-inducing signal transmitted wirelessly to the display tag into electrical power, the electrical power used by the decoder logic unit to update the display.

Gelbman, WO 00/16189 describes smart and dumb implementations of a stand-alone, remotely updateable, remotely alterable, flexible electronic label. The electronic label provides for displaying information in connection with a mammal, non-mammal, an item or location. The label includes a display assembly having electronic ink disposed on a support, one or more antennas for sending or receiving signals corresponding to one of instructions, programs, data or selected indicia to be displayed by said display assembly, a storage element in circuit with the antenna for storing the instructions, programs, data and indicia, and one or more processors for intelligently determining the indicia to be displayed by the display assembly, for controlling and coordinating operation of the label, and for generating output signals for instructing the display assembly to display the indicia.

Visible Tech-Knowledgy, LLC, WO 02/063602 describes smart and dumb implementation of a stand-alone, remotely updateable, remotely alterable, flexible electronic label. The flexibility of the electronic label allows the label to fit into and conform to the shape of the molding used in retail store shelving to display merchandize and warehouse shelving. The flexible, thin label includes a flexible display assembly having electronic ink disposed on a support, one or more antennas for sending or receiving signals corresponding to one of instructions, programs, data or selected indicia to be displayed by the display assembly, a storage element in circuit with the antenna for storing the instructions, programs, data and indicia, and one or more processors for intelligently determining the indicia to be displayed by the display assembly, for controlling and coordinating operation of the label, and for generating output signals for instructing the display assembly to display the indicia.

Visible Tech-knowledgy, LLC, WO 02/071382 describes smart and dumb implementations of a stand-alone, remotely updateable, remotely alterable, flexible electronic label. The electronic label provides for displaying information in connection with a mammal, non-mammal, an item or location. The label includes a display assembly having electronic ink disposed on a support, one or more antennas for sending or receiving signals corresponding to one of instructions, programs, data or selected indicia to be displayed by said display assembly, a storage element in circuit with the antenna for storing the instructions, programs, data and indicia, and one or more processors for intelligently determining the indicia to be displayed by the display assembly, for controlling and coordinating operation of the label (16), and for generating output signals for instructing the display assembly to display the indicia.

The prior art teaches a smart electronic label employing electronic ink, a programmable shelf tagging system, a method of optimizing electronic price label systems, a remote elecroic information display system for retail facilities, a space management system for retail stores, a product monitoring system, a programmable shelf tag and method for changing and updating shelf tag information, and a programmable shelf tag and method for changing and updating shelf tag information. However, the prior art does not teach a smart label with two-way radio communication capability for use in a three-space locating system. The present invention fulfills these needs and provides further related advantages as described in the following summary.

### SUMMARY OF THE INVENTION

The present invention teaches certain benefits in construction and use which give rise to the objectives described below.

The present invention uses a network of ultra wide band (UWB) communication units to form an intercommunication network capable, as a group, of precisely locating objects in three-dimensional space as described in U.S. Pat. Nos. 6,400,754 and 6,385,268 to Fleming, and U.S. Pat. No. 6,300,903 to Richards. These “units” are able to determine their locations in reference to a give point in space. Such a network may comprise a wired or wireless simplex or full duplex electronic geographic positioning system and is advantageously employed in stores and retail establishments.

The term “map” is meant to connote any or all of the following: a diagram describing objects and their geographic positions; a list or table of objects and their spatial coordinates or relative placement; a list or table describing objects and their spatial locations; or a diagram, list or table describing the spatial arrangement of physical locations.

It is an object of the present invention to provide a method and system wherein the identity of assets and their physical locations are associated with one another.

A further object of the present invention is to provide a system and method whereby the physical placement or installation of assets is accomplished according to a pre-determined map of the geographic coordinates at which each such asset should be placed or installed.

It is yet another object of the present invention to provide a system and method whereby the diagram describing the geographic coordinates where the items are intended to be located is automatically “updated” as the assets are installed (i.e., placed into service).

Another object of the present invention is to provide a system and method whereby an inventory of the assets placed into service is obtained and reported.

Another object of the present invention is to provide a system and method whereby an inventory of the assets placed into service is obtained, reported, and verified for compliance purposes.

Another object of the present invention is to provide a system and method whereby a user can construct accurate drawings of buildings, etc.

In a preferred embodiment, the present invention consists of a system that performs the following main functions:

1. Acquires data that identifies the inventory item;

2. Determines the geographical position of that item to the required level of accuracy;

3. Optionally, records the date and time (timestamps) when the identifying data and geographical position have been acquired;

4. Optionally, verifies that the item is already cataloged in a database;

5. Optionally, converts the geographical position to a description of the physical location (e.g., “Building 1, Room 10-17” or “330 7.sup.th Ave, NYC 10001, 7.sub.th floor, NE corner”, etc.); and

6. Optionally, transmits this data to another system for processing.

Clearly, the present invention has application in the fields of retail, wholesale, fire fighting, sports and many other venues and areas of commerce and industry.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a schematic diagram showing an ultra-wide band communications network of the invention;

FIGS. 2A and 2B are flow charts for creating an inventory of assets in accordance with the present invention;

FIG. 3 is a flow chart showing a process to map an office layout;

FIG. 4 is a plan view of an office layout; and

FIG. 5 is a plan view showing an example of how an architectural layout data may be acquired.

### DETAILED DESCRIPTION OF THE INVENTION

With reference to the drawings, the invention is a system and method whereby the physical placement or installation of assets is accomplished according to a pre-determined map of the geographic coordinates in which each asset should be placed or installed. Assets are tracked by their “identities.”

The identity of an asset, such as an inventory item, can be obtained via the use of barcode labels and a reader that are incorporated into the system. Another means of identification is by reference, i.e., associating the identity of that item to an employee, department, system or other relevant object or category. Yet another means of identification is the use of RF ID tags, wherein a tag reader (or reader/writer) is incorporated into the system.

In the latter cases, information is written to an RF ID tag and this functionality can also be incorporated into the system. For example, the system assigns an ID number that is written to the tag, a description (e.g., “Gateway P6-350”), location (“Bldg 1, Rm 10-17”) or other identifying information (e.g., owner name, department, etc.).

The geographical position of the item is obtained in a number of ways. In particular through the use of an ultra-wide band communication network (UWB) as described below which provides high accuracy to handheld receivers. Triangulation techniques are used for locating objects in three-space and such triangulation may use time differential, phase shift differential, and any other well known technique. The distinguishing feature of UWB technique is that it uses very low power in transmitting, but is highly effective in that a significant number of transceiver nodes are used to assure continuous communication.

To accomplish its objectives communication digital information in transmitted and received over relatively short distances, as allowed by FCC rules, employing any well known and common analog or digital wireless communication technique as described in the prior art. Low power ultra wide band (UWB) communication signal technology is used. This is highly suitable in the present application, as will be shown. Likewise, the label reading means may be any well known optical, mechanical, electrical, electrostatic, or magnetic system for reading bar code or other printed coding. Such inventory labels may be radio tags, bar code labels and other well known tags capable of labeling inventory. However, the reader must be of the type that requires its position to be quite close or in contact with the label to be read. Such proximity readers include magnetic swipe types, optical bar code types, and others. When the reader is close to the item, or touching it, and when the communication means is, likewise, very close, the accuracy of the location is improved. Therefore, it is a preferred technique to use a single, miniature hand-held device with contact label reading and communication capabilities. The importance of the proximity will be understood in the following disclosure.

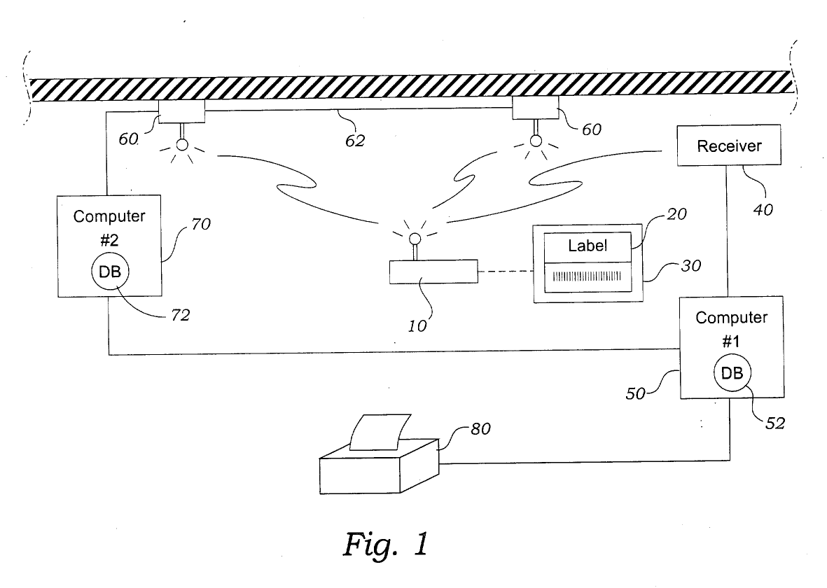

The primary aspect of the present invention is to provide a network of fixed distributed communication nodes 60 positioned over or near inventory stores, etc. The need for this step will become apparent as the present method is further described below. Each of the communication nodes 60 is preferably an electrical signal transceiver device with antenna, capable of both receiving and transmitting wireless electrical signals. Such devices are extremely inexpensive when employed for low power and limited range applications. The number of nodes 60 required in the present method depends upon the size of the inventory stores, the output power of a label transceiver 10, signal to noise ratio in the communication channel space, type of transmission: analog or digital, and other factors well known to communications engineers. Physically, the nodes 60 may be mounted on or from a ceiling of a warehouse, or other building structure, or may be mounted on a network of wires strung or hung from a ceiling or from poles in an indoor or out of doors stores and this is well known in the art. In one embodiment, shown in FIG. 1, the nodes 60 are wireless transceivers interconnected by electrical conductors 62 for sharing information. In addition to transmitting scan information to the receiver 40, the label transceiver 10 also emits a UWB pulsed signal on a continuous basis. UWB transmission packages digital information, in the present case, the identity of the label transceiver 10, that is contained in very short pulses transmitted over a wide spectrum rather than at a specific frequency. The signal is able to use ultra low power, being transmitted at roughly four orders of magnitude below typical output power rating for conventional RF transmissions. Preferably, single UWB monocycles are transmitted from the label transceiver's antenna and by precisely positioning these monocycles in time and using matched antennas at the nodes 60, highly efficient communication is possible. Because a wide spectrum is used, the UWB technique is only able to be employed locally to avoid interference with common carriers. On the other hand, such UWB signals are typically immune to local interference which takes up only a small portion of spectrum. As stated, the UWB signals are received by any of the nodes 60 that are within range of an operating label transceiver 10. As stated, preferably a constant stream of pulsed UWB signals is being transmitted by the label transceivers 10 and received by the nodes 60. Upon receipt, the UWB signals receive a second time stamp, or the UWB signal itself may contain the time stamp from the label transceiver 10. Information contained in the UWB signals are sent to a second data processor 70 or computer where the UWB information from at least three nodes 60, enable a determination of the location of the label transceiver 10 in three-space through triangulation. In one embodiment, the triangulation method for locating the label transceiver 10 in three-space uses discrimination of received time of the signature signals at, at least three of the communication nodes 60, to determine location. This approach requires that the clocks of the nodes 60 are synchronized. Each node receives the UWB signal from the label transceiver 10 and either time stamps it or it may already have a time stamp at the label transceiver 10 at the moment of label recording. In either case, the UWB signals are then communicated, either wirelessly or over wire 62 in FIG. 1 to the second data processor where the time of receipt at each of the three nodes is used to determine the distance to the recorded item from each of the nodes 60 and then the point in three-space where the item 30 is located. Alternately, the triangulation method for locating a label transceiver 10 in three-space uses signal direction discrimination of the signature signals at, at least three of the communication nodes 60, to determine location. This approach uses antenna systems that are able to distinguish within small tolerances, the direction from which a signal is received. Again a triangulation is accomplished from this data. The foregoing discussion uses equipment, parts and techniques that are well known in the art. As mentioned, phase differential triangulation is also well known and applicable in this application using UWB.

Other means of determining a geographical position include direction finding equipment, laser range finders, sonar and optical range finders. It is also possible to use two methods in tandem. For example, the data from a UWB receiver can pinpoint the location of range finding equipment and data from that equipment can be combined to calculate the exact geographical position of a desired item.

Timestamps, consisting of the time and date, are generally associated with a measurement event and can be obtained in one or more ways. For example, an internal clock can be read or, the UWB clock signal is read, or the time can be manually entered. An event occurs when, for example, the barcode label is scanned and a UWB reading is taken. At that point in time, a timestamp is obtained and associated with data taken for the current event.

Patent documents relating to devices that locate and track objects including by GPS include the following U.S. Pat. Nos. 5,751,221, 5,739,765 5,689,238 5,450,070 4,101,873 5,828,306 5,418,537 5,402,466 5,357,560 5,353,376 5,334,974 5,319,698 5,317,620 5,247,564 5,148,471 5,081,667 5,019,802 4,961,212 4,833,477 4,825,457; 4,742,336; 6,550,674 and 5,918,180. The contents of the aforelisted patents are incorporated by reference herein.

The acquisition of UWB position data can be performed in one or more of the following modes of operation:

Data is acquired when the user pushes a button, switch, etc.

Stopwatch mode wherein, at the push of a button, data is acquired continuously (during which time the positioning device can be moved through a range of locations, as would be necessary, for example, to map the path of a cable), and at a user selectable rate, until the button is again pressed.

Data is acquired when the geographic position has changed by a user selected amount, for example, when the position has changed by more than one foot.

Data is acquired when a period of time has elapsed by a user selected amount, optionally at a user selected rate of repetition, for example, when one minute has elapsed and every minute thereafter.

Data is acquired when a specified geographic position or location is reached.

In any of the modes of operation, the present invention determines the position of an asset or location by processing geographic positioning data and applying any of a calibration, tolerance, or offset to the data. For example, a tolerance of one inch in any direction when locating an asset or applying an offset of six inches when determining the “center” of a tree trunk.

In another mode of operation the geographic positioning device alerts the users when a specific location or region has been reached, allowing assets to be installed in the location specified by a predetermined map. Alerts can be visual such as a flashing light; audible such as a buzzer or tone generator; and mechanical such as vibration. Optionally, the frequency with which lights flash, etc. serves as a cue to the user that he is moving nearer or moving away from the proper location.

Some modes of operation may involve two-way communication between the locator device and other devices such as a computer for uploading event data to be processed, downloading configuration data into the locator device, gathering positional data from range finders or UWB receivers, networking to other locator devices, etc. Depending upon the application, wireless technologies such as infrared, radio frequency and wireless networks, e.g., Bluetooth, can be employed in addition to the more “traditional” methods of hardwire connections.

Optionally, the invention maintains a database of known inventory items. The database can be located within the locator device, on a remote computer system, on another networked locator device, or combinations of the above. Additionally, the database can be specific to the locator device, a table, spreadsheet, or a general purpose database such as Microsoft®, Access®, Oracle®, etc.

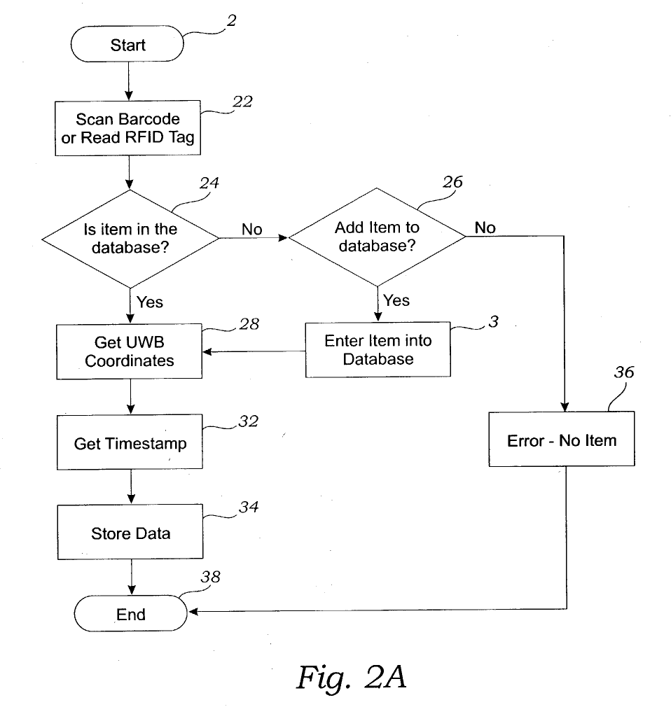

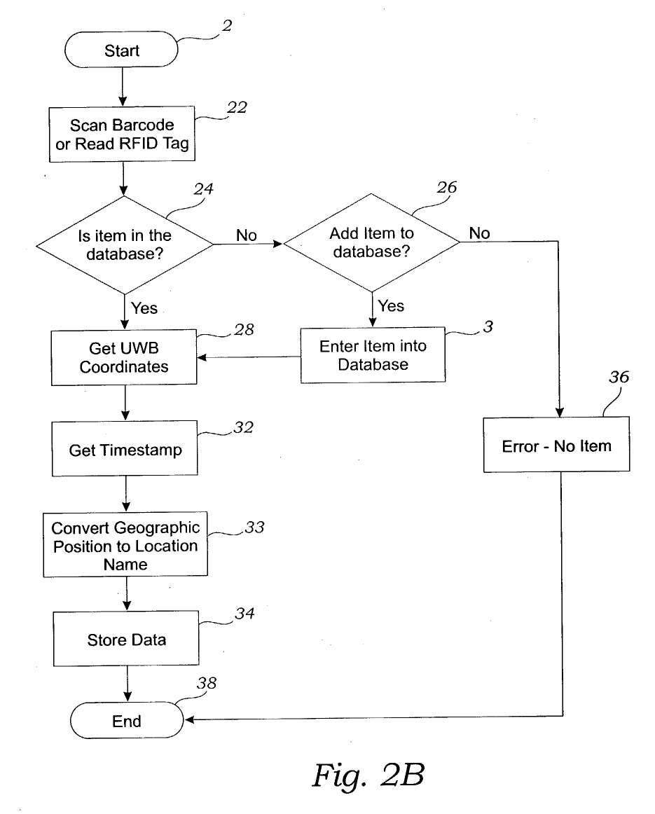

When the barcode is scanned, the scanned code is verified against the database. If an entry is not found, the user may be prompted to enter descriptive information about the item at which point a new inventory item is created. This is illustrated in FIG. 2A. The Figure is a top level flow chart that begins with the start routine 2 and provides further routines 22 which scan bar codes or read an RFID tag which is associated with a physical item. At step 24 the software determines whether an item is in the database. If it is, the program proceeds to step 28 where the positioning system coordinates are obtained and a time stamp is attached (at step 32) and thereafter the data is stored as indicated at 34. The final housekeeping chores are done at the end box 38. However, if an item is not in the database the query step 26 determines whether the item should be added to the database. If so, the program proceeds to step 3 where the item is added to the database and thereafter the software flow is as before. However, if an item is not to be added into the database, an error message is generated at step 36 and the program proceeds to the end box 38.

While a geographical position accurately describes a physical position, it is more natural for people to think in terms of physical locations or regions such as Building 1, Room 10-17 or 330 7th Ave, NYC 10001, 7th floor, NE corner, or Parts Room 3-12, Bin 17, or Electrical Cable Conduit A-17, or Air Handler Return Vent AH-301, Section 1408.

The technology for associating a physical location to a geographic coordinate is well known in the art of Geographic Information Systems and can be readily incorporated into this invention. This is illustrated in FIG. 2B which is identical in virtually every respect to the flow chart of FIG. 2A, but illustrates an intermediate step 33 which converts a geographic position to a location name so that it can be associated with more readily understandable position indicia.

Optionally, this device may be limited to data gathering and processing by a central computer system. Numerous techniques can be incorporated to transfer this data: hardwire connection, docking station, SmartCard, Flash Memory, infrared/RF transmitter-receiver, modem, etc. The data can be read directly by the central computer, a local area network, or a wide area network (e.g., the Internet).

In another embodiment, the system of the invention is used to manage the placement and retrieval of merchandise within a warehouse. As an item is received it may be placed in a location according to pre-determined criteria or simply at random. The location and identity of that item is recorded by the system and that information is updated if it is moved or removed from the warehouse. If the pre-determined criteria requires that the item be placed in or removed from a particular location, the geographic positioning device optionally alerts the user when that location has been reached.

In another embodiment, the system of the invention is used to determine the position of generic items. For example, to “map” the layout of a suite of offices, one selects from a menu of items (e.g., desk, file cabinet, etc.), positions the portable device and then “presses a button” to record that location. Even more precisely, the position of two corners of the desk could be determined, thereby giving the exact orientation of the desk. Processing such position data may be optionally used to produce a layout of the office.

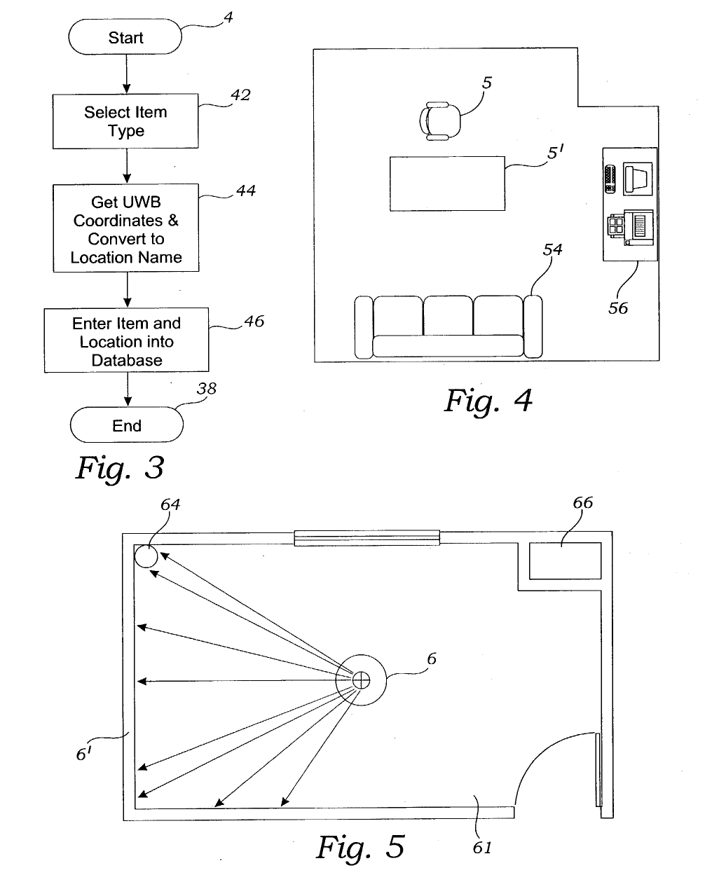

Thus if it is desired to map physical objects in three-space, as shown in FIG. 4, such as a chair 5, a desk 5′, a sofa 54 and a aggregation of items 56, the software flow for mapping such an office layout, as shown in FIG. 3, has an initialization routine 4 which is followed by a step 42 for selecting an item type and thereafter obtaining UWB coordinates. At step 44 the coordinates are converted to a location name. In the subsequent step 46, the item and the location are entered into the database and then the program exits at 38, to obtain an electronic or database definition of the layout of an office.

In another embodiment, the invention is used in a similar manner to produce survey, landscaping and topographical data wherein such data is processed to identify and map the location of trees, plants, sheds, and other structures. Knowledge of the topography is very important in determining drainage conditions. Similarly, a user, such as a landscaper, can use the system onsite to “mark” the position of various trees and plants that are to planted there at a later time.

In another embodiment, the invention is used to update architectural layouts. It is common when remodeling in a large office building for there to be minor differences in the interior dimensions from floor to floor. These differences are typically due to electrical wiring, heating and ventilating, interior walls, etc. Further, many times alterations and changes are made which are either poorly documented or not documented at all. While minor, an architect must take these into account when drafting new plans. Typically, this means taking numerous measurements even if one is working with an existing floor plan.

For example, an item such as a wall is selected from a computer display, scanning a barcode on the diagram or entering a part number. The locator device receives the geographic coordinates (and tolerances) where the wall starts and ends. As the user moves the locator device, it visually or audibly notifies the user to “mark” the locations when each of those coordinates is reached and they are within the allowable tolerances. This may be done in a number of ways such as a “getting warmer/getting colder” tone that changes in frequency or pitch, or by use of a visual display that represents the current position of the locator relative to the diagram, allowing the user to move the locator until the display shows it to coincide with the desired point on the diagram. Optionally, when a first item is positioned, the next item is automatically selected for the user to layout. Additionally, multiple items may be selected, in which case the locator device directs the user to position each in turn.

Optionally, the order in which items are to be located is optimized according to criteria such as distance, order of precedence, installation time, availability of other resources (e.g., a forklift), etc. Optionally, the present invention verifies that items have been positioned in accordance to the diagram by taking an additional location measurement and comparing that against the intended location. In another mode of operation of this embodiment, and as a variant of a method previously described, the present invention determines after the fact the actual physical geographic placement of individual assets and “calibrates” the diagram describing the geographic coordinates where the items were intended to be placed. These calibrations are also used to facilitate the construction process.

For example, the device can incorporate range finding equipment and, optionally, a GPS or UWB receiver. The equipment is placed in the center of the area, e.g. a room 6′ (FIG. 5), to be surveyed and range data is gathered while the device is rotated through 360 degrees of arc. The resulting data now represents a “floor plan” which is used to generate a new or update an old architectural layout. In FIG. 5, an architectural layout is produced by placing the physical object locator 6 in the center of the room 6′ and rotating it to locate, for example, the pipe 64 or the HVAC duct 66 resulting in a map of physical objects which defines the location of items in terms of their angular and range locations, i.e., polar coordinates. This data can be easily converted to other data formats such as, for example, a Cartesian coordinate system or a matrix system.

Furthermore, UWB data also produces precise elevation data which is used in this context to determine the actual floor of the building or buildings where objects are located. For example, by taking two calibrating elevation measurements, such as on the first and second floors, the locations of the other floors are readily deduced.

In another embodiment, an architectural diagram, whether created by the present invention or by other means, describes the location of various interior walls, doors, windows, plumbing, ventilation, electrical equipment, etc. to be built or installed. Whether such items are pre-fabricated or custom built, a contractor must locate where and in what order these are to be installed. Whereas the previously described functions of the present invention have had as one of their objectives the creation of a diagram from data gathered via multiple physical location readings that are associated with existing physical objects, the invention also “goes the other way” in that it allows the objects described on an existing diagram to be conveniently associated with the corresponding location in physical space where the objects should be located and, if required, in a specified order.

In another mode of operation of this embodiment and as a variant of a method previously described, the present invention determines, after the fact, the actual physical geographic placement of individual assets and “calibrates” the diagram describing the geographic coordinates where the items were intended to be placed. These calibrations are also used to facilitate the construction process.

Even though offices, homes, buildings, etc. are constructed according to architectural plans, the true physical placement of walls, doors, plumbing, electrical wiring and receptacles, etc. can and will vary.

For example, the user selects an item such as a wall from a computer display, scanning a barcode on the diagram or entering a part number. Using the locator device, the user records the geographic coordinates where the wall starts and ends. Those locations are used to update the architectural plans. Usefully, the calibrated data is used to facilitate the construction process in determining the correct amount of raw materials that are required.

For example, when a water heater is installed in a small office the water supply and delivery lines are routed through the floors and walls to the lavatory sinks. If each sink and the water heater are located precisely according to the diagram and the walls and floors are also constructed in precise accordance to the diagram, all of the water pipes could be pre-fabricated saving the plumbers and contractors both time and money. In reality, a misalignment of a single item by only an inch makes this totally impractical. However, the present invention makes it practical to pre-fabricate the water pipes by using actual geographic coordinates to determine all of the necessary bends, turns and runs.

In yet another embodiment, the present invention provides a system and method whereby an inventory of the assets placed into service is obtained and reported.

In some industries, such as the construction industry, it is common to reimburse contractors according to equipment installed. Typically, contractors submit a bill of materials for reimbursement. Producing such a bill of materials can be burdensome and error-prone as can be verifying that such materials have actually been installed.

The present invention is used in either of two ways: to record the location of each component as it is installed; or in an inventory mode wherein its location is determined. In either method, a timestamp is also recorded and used in the production of a bill of materials.

Optionally, the inventory of installed items is used to produce a list for demonstrating compliance with local building codes and/or is correlated against a list of local building codes in order to verify compliance.

Optionally, the present invention records the actual geographic location where each item is installed and that data used to update and/or construct accurate drawings of buildings and their components. In this instance, a location is not simply a “point in space” but a region of space such as that used for heating ducts, electrical conduits, water supply, sewerage, etc.

For example, the placement of heating, ventilation, and air conditioning ducts, controls and equipment; electrical switches, fixtures, boxes, etc.; plumbing valves, fixtures, etc. can and do vary from what may be planned. As items are installed, the locator device records the geographic location of each. These locations are processed to produce an accurate architectural diagram.

Optionally, when integrated with a drawing program such as Autocad® or other geographic methods, the locator device providing geographic coordinates in real-time acts as a GUI “pointing” device (e.g., computer mouse) to first select and then place items in a drawing. For example, drawing a line involves marking the starting and ending points; a circle involves marking the center and radius; a curve is little more then connecting dots; etc.

There are numerous benefits to this invention. Most notably, it combines location with identification data to produce accurate inventories of physical assets; reduces geographical positions to easy to understand location names; may be used to produce accurate office layouts; may be used to produce a bill of materials suitable for such purposes as demonstrating compliance with building codes and submission for reimbursement; generating new or updated floor plans; producing accurate landscaping and topographical maps; placing and recording the location of objects such as office equipment, trees and shrubbery, plumbing and electrical equipment, etc.; updating and/or to produce accurate architectural plans and drawings; and as a GUI pointing device to a drawing program.

Furthermore, the event data produced by the present invention can be used to generate various reports such as a bill of materials and inventory lists. The data can be exported to other databases, tables, and files such as a spreadsheet.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method for mapping the locations of objects relative to physical structures or locations, relative to which the objects are spatially arranged, the method comprising the steps of: moving a locator tool to a position at or moving along the objects and receiving a first input from an ultra-wide band geographic positioning network by which the locator tool is able to determine its own location and thereby the location or locations of the objects; receiving at the locator tool a second input by which the identity of objects being mapped are identified; and coupling outputs of the locator tool to a computer which receives location information and object identity information from the locator tool and creates a location map for a plurality of the objects.

2. The method of claim 1, in which the ultra-wide band network comprises a plurality of local transceivers fixed relative to the physical structures or locations.

3. The method of claim 2, including obtaining with the tool a plurality of location readings of a physical object to obtain a map of a physical space occupied by the object relative to surrounding physical structures.

4. The method of claim 3, including mapping the positions of the physical structures which contain the objects to be mapped.

5. The method of claim 1, in which receiving the second input comprises reading bar code labels on the objects.

6. The method of claim 1, further including identifying objects by listing identification indicia which comprises one or more of: employee names, company departments, product category or product system with which objects are associated.

7. The method of claim 1, in which the tool identifies the identity of objects by receiving an input from RF tags on the objects.

8. The method of claim 1, further including providing object descriptions in association with said objects.

9. The method of claim 1, including listing original locations of the objects.

10. The method of claim 1, in which the tool comprises a receiver of an ultra-wide band geographic positioning system.

11. The method of claim 1, in which the tool receives information from range finders which are located in the vicinity of the objects.

12. The method of claim 11, in which the range finders are operable optically.

13. The method of claim 1, in which the range finders are operable by receiving sonar beam location information.

14. The method of claim 1, in which the tool determines its location by receiving inputs from range finders which in turn receive their respective locations from the ultra-wide band geographic positioning network.

15. The method of claim 1, including time stamping object location readings.

16. The method of claim 1, in which the tool is actuated to receive geographic positioning data in response to a manual actuation.

17. The method of claim 1, including initiating the tool to acquire geographic position data continuously as the tool is moved through a range of locations.

18. The method of claim 1, including obtaining geographic position data every time the position of the tool has changed by more than a predetermined distance.

19. The method of claim 1, including acquiring geographic data when a specified geographic position or location has been reached.

20. The method of claim 1, including alerting a user when a specific location or region has been reached.

21. The method of claim 1, including providing alerts to a user when the user approaches or moves away from a predetermined location.

22. The method of claim 1, including maintaining a database of known objects to be associated with the objects being mapped by the tool.

23. The method of claim 22, including correlating the identity of objects with objects that have been predefined in the database.

24. The method of claim 1, including identifying objects by their address locations.

25. The method of claim 1, including mapping the placement and retrieval of objects which comprise merchandise located within a warehouse.

26. The method of claim 1, including operating the tool to alert a user not to position an object where it does not belong.

27. The method of claim 1, including creating a topography of a landscape.

28. The method of claim 1, including creating architectural layouts of objects.

29. The method of claim 1, including obtaining positional data for the objects which includes elevation data.

30. The method of claim 28, in which the architectural layout includes a description of architecturally relevant data selected from a group including one or more of: interior walls, doors, windows, plumbing, ventilation fixtures, electrical equipment, and furniture.

31. The method of claim 1, including operating the tool to re-calibrate the relative locations of objects which are already described in a map which lists their original geographic coordinates and/or relative placements.

32. The method of claim 1, including operating the tool for a building construction process and including determining the correct amount of raw materials that are required for the construction process.

33. The method of claim 32, deploying the tool to enable the prefabrication of objects which extend over substantial distances relative to physical structures.

34. The method of claim 1, including verifying the locations of objects against building specifications which defines rules or codes as to their proper location.

35. A system for mapping the locations of objects relative to physical structures or locations, relative to which the objects are spatially arranged, the system comprising: a locator tool that can be positioned at or moved along the objects, the locator tool receiving a first input from an ultra-wide band geographic positioning network, by which the locator tool is able to determine its own location and thereby the location or locations of the objects; the locator tool receiving a second input by which the identity of objects being mapped are identified by the locator tool; and a computer coupled to the locator tool and receiving from the locator tool, location information and object identity information and creating a location map for a plurality of the objects.

36. The system of claim 35, in which the tool receives plural inputs from a geographic positioning network by which the tool is able to determine its own location.

37. The system of claim 35, the locator tool including a facility for reading bar code labels located on the objects.

38. The system of claim 35, in which the computer includes a facility which identifies objects by associating it with identification indicia which comprises one or more of: employee names, company departments, product category or product system.

39. The system of claim 35, in which the locator tool includes a facility which is able to receive object identification inputs from RF tags located on the objects.

40. The system of claim 35, further including range finders located spatially about the physical structures and the locator tool communicating with the range finders.

41. The system of claim 35, in which the locator tool has a manual actuator which, when actuated, activates the locator tool to receive geographic positioning data.

42. The system of claim 35, in which the locator tool has a facility which produces a user alert when a specific location or region has been reached by the locator tool.

43. The system of claim 35, further including a database of known objects and a correlating facility which correlates the identity of objects being located with objects that have been predefined in the database.

44. The system of claim 35, further including a facility which enables the creation of an architectural layout when the locator tool is located at or moved along objects in a building structure where the objects are selected from a group including one or more of: interior walls, doors, windows, plumbing, ventilation fixtures, electrical equipment and furniture.

45. The method of claim 1, further including creating a bill of materials for a construction site.
